(19) United States
(12) Patent Application Publication
(10) Pub. No.: US 2026/0236881 A1
(43) Pub. Date: Aug. 13, 2026

(54) Systems and Methods for Asset Tracking and Governing Access to the Access Tracking across Owners and Delegates

(71) Applicant: T-Mobile Innovations LLC, Overland Park, KS (US)

(72) Inventors: Mark Bales, Lee’s Summit, MO (US); Lyle Bertz, Lee’s Summit, MO (US)

(21) Appl. No.: 19/049,991

(22) Filed: Feb. 10, 2025

(51) Int. Cl. G06Q 10/0833; H04L 9/40

(52) U.S. Cl. CPC G06Q 10/0833; H04L 63/083

(57) ABSTRACT

A method comprises generating an asset data structure for storing asset data associated with a physical asset based on a new asset data structure request received from an owner system, generating an owner system policy and a delegate system policy governing access to the asset data structure by the owner system and a delegate system based on new asset data structure request, and performing a read operation or an append operation on an asset entry in the asset data structure based on an operation request received from delegate system based on the delegate system policy and a time period associated with the asset entry.

### CROSS-REFERENCE TO RELATED APPLICATIONS

None.

STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Package tracking solutions may record the location and events associated with a shipment as it traverses a supply chain. The records may be generated through the utilization of data logging devices, which may be temporarily allocated to a package and subsequently repurposed for future shipments. However, the organizations that access the tracking data may be unknown or may change over time. This may create a problem for the organizations, because the data may in some cases be retained only for a brief period, risking premature deletion before the data is accessed; or the data may be retained beyond the allotted time indicated data retention policies, increasing legal liabilities and cost.

### SUMMARY

In an embodiment, a method implemented in a communication network to perform physical asset tracking using an asset data structure and to control access to the asset data structure is disclosed. The method comprises receiving, by an application executing at an asset information service system, from an owner system associated with an owner organization, a new asset data structure request to create the asset data structure for storing asset data associated with a physical asset, in which the new asset data structure request comprises a device identifier, one or more delegate system identifiers identifying one or more delegate systems corresponding to one or more delegate organizations, asset permission data, or a digital signature associated with the owner system. The method further comprises authenticating, by the application executing at the asset information service system, the digital signature to verify an identity of the owner system from which the new asset data structure request is received, transmitting, by the application executing at the asset information service system, a certificate to the owner system in response to authenticating the digital signature, generating, by an application executing at a grant and ownership tracker system, time period-to-organization mappings indicating time periods during which an owner organization or a delegate organization had primary control of the physical asset, and generating, by the application executing at a grant and ownership tracker system, an owner system policy and a delegate system policy governing access to the asset data structure based on at least one of the asset permission data or the one or more delegate system identifiers. The method further comprises governing, by the application executing at a grant and ownership tracker system, access to the asset data structure based on at least one of whether a request to access the asset data structure is received from the owner system or the one or more delegate systems, the owner system policy, the delegate systems policy, or the time period-to-organization mappings, and transmitting, by the application executing at the asset information service system, a transaction receipt comprising data describing an operation performed with respect to an asset entry in the asset data structure.

In another embodiment, a system is disclosed. The system comprises an asset information service system and a grant and ownership tracker system. The asset information service system comprises a first memory, a first processor, a first application stored at the first memory and executable by the first processor, which when executed by the first processor, causes the first application to be configured to receive, from a requestor, a request to perform an operation with respect to an asset entry in an asset data structure that stores asset data associated with a physical asset, the request including credentials, a device identifier identifying the physical asset, and operation data describing the operation to be performed on the asset data structure, and verify the credentials received in the request to authenticate the requestor being authorized to at least partially access the asset data structure. The grant and ownership tracker system comprising a second memory, a second processor, and a second application stored at the first memory and executable by the first processor, which when executed by the first processor, causes the second application to be configured to determine whether the requestor is permitted to perform the operation with respect to the asset entry in the asset data structure based on at least one of an owner system policy, a delegate system policy, time period-to-organization mappings, or a prior transaction receipt. The first application of the asset information service system is further configured to perform the operation on the asset entry of the asset data structure when the requestor is permitted to perform the operation with respect to the asset entry in the asset data structure, and transmit a transaction receipt describing a timing and success of the operation performed on the asset entry in the asset data structure.

In yet another embodiment, a method is disclosed. The method comprises generating, by an application executing at an asset information service system, an asset data structure for storing asset data associated with a physical asset based on a new asset data structure request received from an owner system, generating, by an application executing at a grant and ownership tracker system, an owner system policy and a delegate system policy governing access to the asset data structure by the owner system and a delegate system based on new asset data structure request, and performing, by the application executing at an asset information service system, a read operation or an append operation on an asset entry in the asset data structure based on an operation request received from delegate system based on the delegate system policy and a time period associated with the asset entry.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a communication network according to an embodiment of the disclosure.

FIG. 2 is a block diagram illustrating various examples of the use of internal device identifiers (DIDs), public DIDs, and group DIDs in asset tracking by the communication network of FIG. 1 according to various embodiments of the disclosure.

FIG. 3 is a message sequence diagram illustrating a method of creating an asset data structure in the communication network of FIG. 1 according to various embodiments of the disclosure.

FIG. 4 is a message sequence diagram illustrating a method of adding or removing a delegate system with access to at least part of the asset data structure in the communication network of FIG. 1 according to various embodiments of the disclosure.

FIG. 5 is a message sequence diagram illustrating a method of modifying owner system policies and/or delegate system policies of the asset data structure in the communication network of FIG. 1 according to various embodiments of the disclosure.

FIG. 6 is a message sequence diagram illustrating a method of reading or appending data in the asset data structure in the communication network of FIG. 1 according to various embodiments of the disclosure.

FIG. 7 is a message sequence diagram illustrating a method for changing ownership of the asset data structure in the communication network of FIG. 1 according to various embodiments of the disclosure.

FIG. 8 is a flowchart of a first method of asset tracking and governing access to the asset tracking according to various embodiments of the disclosure.

FIG. 9 is a flowchart of a second method of method asset tracking and governing access to the asset tracking according to various embodiments of the disclosure.

FIG. 10 is a block diagram of a computer system implemented within the communication network of FIG. 1 according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

Package tracking solutions may use radio frequency identification (RFID) technology, which may enable real-time or periodic monitoring of assets (e.g., physical items or devices (or physical assets), digital assets (e.g., software binary files, software artifacts, etc.)) as the assets move through various stages in a supply chain. For example, each asset (or package) may be detachably attached with an RFID tag, which emits data that may ultimately be sent to a tracking system. Customers (e.g., companies) may access the data stored at the tracking system to track data related to the asset/package (e.g., location, status, environment, temperature, humidity, etc.). As the package transitions between stages in the supply chain (e.g., manufacturer, transporter, to warehouse), the temporary control of the package may shift, although the owner of the package may ultimately remain the same (e.g., the manufacturer or the end customer). Since the control of the package may shift, the permissions/data access at the tracking system may also have to change.

Physical assets may in some cases be tracked by scanning barcodes or RFID tags at each point in the shipping process—from the initial pickup to sorting facilities, distribution centers, and finally the delivery destination, and this data may be compiled in a document. At each transfer point, the package is scanned again, which creates a digital “breadcrumb trail” of timestamps, locations, and handling details. These data points are then aggregated into the document and may be made available through tracking portals, allowing senders, recipients, and other stakeholders to monitor the package's journey from origin to destination.

However, data retention at these package tracking systems present several technical challenges, for example, when retention periods are either too long or too short, creating potential technical, legal, and operational issues. For example, if data is retained for too long, the system can encounter technical problems such as excessive database growth, which leads to slower query performance, higher storage costs, and potential scalability issues. Over-retention may also increase the risk of data breaches or unauthorized access. On the other hand, if data is retained for too short a period, critical operational and compliance risks may arise. From a regulatory perspective, failure to meet mandatory retention periods (e.g., government requirements to retain shipping data for customs, tax, or trade compliance, often spanning several years/decades) can result in fines, legal penalties, etc. Operationally, short retention periods may prevent business from accessing historical data for general use, trend analysis, performance optimization, or dispute resolution.

The present disclosure addresses the foregoing technical problems by providing a technical solution in the technical field of asset data monitoring and tracking, using an immutable asset data structure that is retained based on the usage/access of the data in the asset data structure. The embodiments disclosed herein are directed to controlling access to/permissions of owner systems and delegate systems with respect to the asset data structure. An owner system may be a system operated by an owner organization that owns the asset, while a delegate system is a system operated by a delegate organization that may temporarily control the asset.

An asset data structure may be associated with one or more assets, may contain data received by an RFID tag on a physical asset (or on the packaging of the physical asset), and may be managed by an asset information service (AIS) system and a grant and ownership tracker (GOT) system. The AIS system and the GOT system may manage the asset data structure based on the ownership of the asset and the delegate organizations that may temporarily control/operate the asset and based on the use/access of the asset data structure, in a manner that may avoid the aforementioned retention issues with respect to the data maintained in the asset data structure.

The asset data structure may refer to an immutable, tamper-proof data structure of asset data describing an asset. For example, the asset data structure may be formatted as a blockchain, distributed ledger, tree, or other data structure that may store data, which may include one or more asset entries. The asset entries may only be read or appended to (i.e., may not otherwise be modified or altered). The asset data may include data received from tags (e.g., RFID tags) positioned on the physical asset or on the packaging of the physical asset (e.g., location data, temperature data, humidity data, environment data, status, etc.). The asset data may also include data received from owner systems and delegate systems that may be using/controlling the asset. For example, the asset data structure may be stored at a data store (e.g., one or more distributed or co-located memories), and each asset entry may carry asset data received from or associated with an owner of the asset or a delegate of the asset.

The AIS system may refer to a system (e.g., collection of servers running various applications) that may process service requests received from owner systems and delegate systems, verify an identity of a requestor (e.g., owner system/delegate system) using a verifiable credential, and performs various actions with respect to the asset data structure based on a service request and various policies managed by the GOT system. The GOT system may refer to a system that may carry different policies and types of data that may be used by the GOT system to determine whether a requestor (e.g., owner system/delegate system/other system) is permitted to perform an action with respect to the asset data structure.

The GOT system may include a data store for storing the aforementioned policies and data. The policies may include owner system policies and delegate system policies. An owner system policy may include instructions (e.g., logic/code) that may be used to define whether an owner system is permitted to perform various actions or tasks with respect to a specific asset data structure. Owner system policies may only apply to owner systems operated by current owners of an asset data structure and/or the associated asset. Similarly, a delegate system policy may include instructions (e.g., logic/code) that may be used to define whether a delegate system is permitted to perform various actions or tasks with respect to an asset data structure. Delegate system policies may apply to delegate systems operated by a marked delegate of an asset data structure and/or the associated asset.

The data store at the GOT system may also store owner-to-delegate mappings. The owner-to-delegate mappings may include mappings between identifiers of owner systems (operated by owners) and identifiers of registered/acknowledged delegate systems (operated by delegates) of an asset data structure and/or associated asset. An owner refers to the primary, long-time stakeholder of an asset and the associated asset data structure. For example, the owner may have full, unrestricted control over the asset and its data, ownership may not be time-bound unless explicitly transferred or relinquished, the owner may bear ultimate responsibility for the asset and data, only an owner may have the right to grant temporary delegate to one or more delegates, etc. Meanwhile, a delegate may refer to a temporary custodian or agent with limited rights over the asset and the associated asset data structure, sometimes acting on behalf of the owner. For example, delegates may have restricted permissions to specific types of data in the asset data structure, delegates may not transfer ownership or delete records, delegation may be temporary and limited to a specific period of purpose, delegates may only act within the scope granted by the owner, etc. The data store at the GOT system may also store time period-to-organization mappings, which may indicate time periods during which an owner system is the owner of an asset data structure and time periods during which a delegate system is a delegate of the asset data structure.

The data store at the GOT system may also store a status of an asset data structure (e.g., active and currently being accessed/appended to, archived and not currently being accessed/appended to, forgotten or disassociated from an owner/delegate, etc.). The type of storage of the asset data structure (e.g., more expensive storage, less expensive storage, removal of the asset data structure, etc.) may be based on the status of the asset data structure, and the status of the asset data structure may be based on a frequency of access/additions to the asset data structure.

The data store at the GOT system may also store various types of device identifiers, such as an internal device identifier (DID), public DID, and group DID, and each asset data structure may be associated with one or more DIDs. The internal device identifier may refer to a permanent, immutable identifier of the asset, defining a permanent identity of the asset. The public DID may refer to alias identifiers issued by owners and delegates (in some cases, temporary), which may be used to identify the asset in service requests. The group DID may refer to an identifier that can be mapped to multiple different assets, for example, based on a shared location of the multiple different assets (e.g., multiple physical assets may be in transport on a truck together). The data store at the GOT system may also store asset ownership data, specifying details regarding the current and prior owners and associated owner systems of an asset data structure (e.g., identifiers of current and prior owners and the associated DIDs).

In operation, the AIS system may receive various types of service requests to perform an operation (e.g., action or task) with respect to an asset/asset data structure from requestors. The service request may be, for example, a request to create an asset data structure, a request to perform a read or append operation on an asset data structure, a request for the status of the asset data structure, a request to modify/create a policy with respect to the asset data structure, or a request to change ownership of the asset data structure. Regardless of the type of service request, the service request may include at least a DID (e.g., internal DID, public DID, and/or group DID) associated with the asset data structure or asset, an identifier/address of the requestor, and credentials associated with the requestor.

The requestor may be an owner system of the asset data structure, a delegate system of the asset data structure, or neither. Therefore, an application at the AIS system may first verify the identity of the requestor using a certificate authority system. The certificate authority system may include an authentication application and may store different verification credentials associated with authorized requestors, for example, digital signatures and certificates granted to authorized requestors. The application at the AIS system may pass the credentials received in the service request from the requestor to the certificate authority system. The authentication application at the certificate authority system may verify the received credentials with the stored credentials to ensure that the requestor is authorized to transmit service requests to the AIS system.

Once the requestor is verified, the application at the AIS system may then determine whether the requestor is permitted to perform the operation with respect to the asset data structure associated with the DID identified in the service request. When the service request is a create asset data structure request received by an owner system, the application at the AIS system may first determine whether the identifier of the requestor owner system matches the ownership data of the asset stored at the GOT system. As mentioned above, the ownership data includes mappings between identifiers of owner systems and DIDs of different assets, and this data may be used to verify that the create asset data structure request is indeed received from the verified owner of the DID identified in the request. The create asset data structure request may additionally include (in addition to the DIDs and credentials) delegate data and asset permission data for the new asset data structure. The delegate data may include identifiers of delegate systems that are authorized delegates of the asset data structure. The asset permission data may indicate actions and tasks that may be permitted to be performed and/or prohibited from being performed by owner systems 115 and delegate systems 118 with respect to the newly created asset data structure 160 (e.g., certain delegate systems 118 may only be permitted to read asset entries 163 that were added to the asset data structure 160 by the respective delegate systems 118, certain delegate systems 118 may be prohibited from appending to the asset data structure 160, etc.).

The application at the GOT system may use the asset permission data received in the create asset data structure request to generate the owner system policies and delegate system policies for the newly created asset data structure. The application at the AIS system may then generate the asset data structure with a first asset entry. For example, when the asset data structure is a blockchain, the first entry may be a first block, which may include a header with metadata describing the owner/delegates, timestamps, etc. The application at the AIS system may log the creation of the asset data structure in a system log and send a transaction receipt to the owner system, for example, indicating the successful creation of the asset data structure, a timestamp of creation, storage data/pointers, and/or other data (including data from the create asset data structure request).

Subsequently received service requests (e.g., requests to add or remove a delegate, requests to modify owner system policies, requests to access/modify the asset status, requests to read asset entries from the asset data structure, requests to append an asset entry to the asset data structure, requests to change ownership of the asset data structure, etc.) may each be based on the owner system policies and delegate system policies created for the asset data structure. For example, an owner system policy or delegate system policy may indicate whether a requestor is permitted to add/remove a delegate, modify system policies, access/modify an asset status, read asset entries, append to the asset data structure, and/or change ownership of the asset data structure. The owner system policy and delegate system policies may further be based on the time period-to-organization mappings, owner-to-delegate mappings, and asset ownership data stored at the GOT system. In this way, the application at the AIS system and the application at the GOT system may work together to determine whether the requested operation indicated in a received service request is permitted for the requestor at the time requested, and if permitted, the application at the AIS system may perform the operation with respect to the asset data structure.

In this way, the embodiments disclosed herein serve to conserve network capacity, and processing and power resources by substantially resolving the aforementioned data retention issues related to the tracking and monitoring of assets. For example, the embodiments disclosed herein track ownership of an asset and allow all stakeholders (not just owners, but delegates as well) to contribute to asset-related data. Therefore, the embodiments disclosed herein ensure the stakeholder identity can be trusted, ensure that asset data is accessible by permission only, ensure that asset data once written cannot be tampered with, and enable stakeholders to append asset data structures with asset data at a much later time (i.e., out of order writes) in an authorized manner. The asset data structure may be maintained based on a frequency of usage/access/appending to the asset data structure, and may be archived/removed/forgotten (e.g., changed status) in response to service requests from authorized requestors. By tracking ownership and delegates over time and maintaining ownership data, delegate data, status data, etc., as disclosed herein, the asset data structure can be retained at the data store only for as long as needed per the current owner/delegates of the asset data structure. Therefore, in general, the embodiments disclosed herein serve to increase system capacity by ensuring that asset data is retained specifically for the owners/delegates that access the data, and then is archived based on the owner/delegate usage (as opposed to retaining asset-related data for an unnecessarily long period of time).

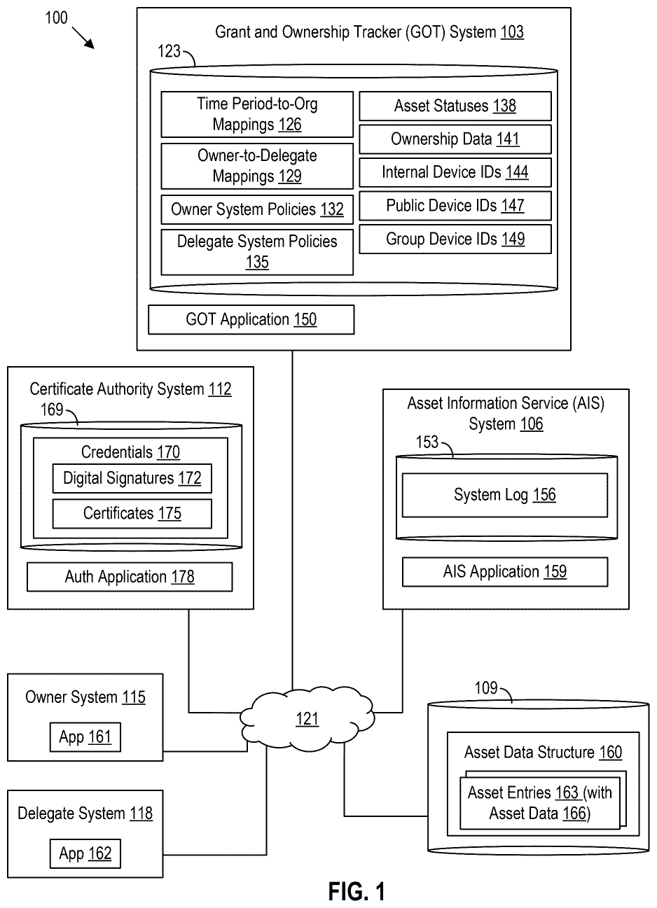

Turning now to FIG. 1, a communication system 100 is described. The communication system 100 system in FIG. 1 includes a GOT system 103, an AIS system 106, an asset data store 109, a certificate authority system 112, an owner system 115, a delegate system 118, and a network 121. The network 121 may be one or more private networks, one or more public networks, or a combination thereof. While the GOT system 103, AIS system 106, asset data store 109, and certificate authority system 112 are shown as separate from one another, it should be appreciated that two or more of the GOT system 103, AIS system 106, asset data store 109, and certificate authority system 112 may be logically located together and/or operated by the same entity.

The asset data store 109 may be one or more distributed and/or co-located memories that may store asset data structures 160, each representing a different asset (e.g., a physical asset such as a device or a software asset such as a binary file or another type of software artifact). The examples disclosed herein may refer to a physical asset. However, it should be appreciated that the asset being described in the asset data structure 160 may also be a software asset.

The asset data structure 160 may refer to an immutable, tamper-proof data structure of asset data 166 describing a physical asset, and may be specifically associated with a DID (e.g., internal DID 144, public DID 147, and/or group DID 149 of the physical asset). For example, the asset data structure 160 may be formatted as a blockchain, distributed ledger, tree, or other data structure that may store data, which may only be read or appended to (i.e., may not otherwise be modified or altered). The asset data 166 may include data received from tags (e.g., RFID tags) positioned on the physical asset or on the packaging of the physical asset (e.g., location data, temperature data, humidity data, environment data, status, etc.). The asset data 166 may include data received from owner systems 115 and delegate systems 118 that may be using/controlling the physical asset. The asset data structure 160 may include one or more asset entries 163, each carrying asset data 166 received from or associated with an owner of the physical asset or a delegate of the physical asset represented by the asset data structure 160.

The owner system 115 may be a device, server, and/or collection of hardware and software resources (e.g., distributed or co-located servers with computing and memory resources) that run one or more applications 161. The owner system 115 may be owned and operated by an owner of a physical asset, and asset data 166 describing the physical asset may be stored in asset entries 163 of an asset data structure 160, stored at the asset data store 109 (e.g., one or more memories). As described above, an owner refers to the primary, longer-time stakeholder of a physical asset and the associated asset data structure. For example, the owner may have full, unrestricted control over the physical asset and its data, ownership may not be time-bound unless explicitly transferred or relinquished, the owner may bear ultimate responsibility for the asset and data, only an owner may have the right to grant temporary delegate to one or more delegates, etc. The application 161 may be stored in a memory of the owner system 115 and executable by a processor of the owner system 115 to generate and transmit service requests to the AIS system 106, and receive responses (e.g., asset data 166 and/or transaction receipts) from the AIS system 106.

The delegate system 118 may be a device, server, and/or collection of hardware and software resources (e.g., distributed or co-located servers with computing and memory resources) that run one or more applications 162. The delegate system 118 may be owned and operated by a delegate expressly assigned by the owner of a physical asset/asset data structure 160 (e.g., in a create new asset data structure request). A delegate may be temporary custodian or agent with limited rights over the physical asset and the associated asset data structure 160. For example, the delegate system 118 may, if permitted, access/store asset data 166 describing the physical asset in asset entries 163 of the asset data structure 160. Delegates may have restricted permissions to specific types of data in the asset data structure 160, delegates may not transfer ownership or delete asset entries 163, delegation may be temporary and limited to a specific period of purpose, delegates may only act within the scope granted by the owner, etc. The application 162 may be stored in a memory of the delegate system 118 and executable by a processor of the delegate system 118 to generate and transmit service requests to the AIS system 106, and receive responses from the AIS system 106.

The GOT system 103 may be a collection of hardware and software resources (e.g., distributed or co-located servers with computing and memory resources) with a data store 123 and a GOT application 150. The GOT application 150 may be instructions stored in a memory of the GOT system 103 and executable by a processor of the GOT system 103. The data store 123 may store time period-to-organization mappings 126, owner-to-delegate mappings 129, owner system policies 132, delegate system policies 135, asset statuses 138, ownership data 141, internal DIDs 144, public DIDs 147, and group device IDs 149. The time period-to-organization mappings 126 may indicate time periods during which an owner system 115 is the owner of an asset data structure 160 and time periods during which a delegate system 118 is a delegate of the asset data structure 160. For example, a time period-to-organization mapping 126 may indicate that a physical asset and associated asset data structure 160 may have been owned by the owner system 115 for a first period of time. The time period-to-organization mapping 126 may indicate that, during the first period of time, a first delegate system 118 was a delegate of the physical asset and associated asset data structure 160 during a second period of time, and that a second delegate system 118 was a delegate of the physical asset and associated asset data structure 160 during a third period of time.

The owner-to-delegate mappings 129 may indicate the owner and registered/acknowledged delegates for an asset data structure 160, in some cases, with the associated time periods (i.e., the time period in which an owner may be registered/acknowledged as the owner of the asset data structure 160 and the time period in which the delegates may each be registered/acknowledged as a delegate of the asset data structure 160). For example, the owner-to-delegate mappings 129 may include, for each asset data structure 160, an identifier of the current owner system 115 and identifiers of the delegate systems 118.

The owner system policies 132 may include instructions (e.g., logic/code) that may be used to define whether a requestor owner system 115 is permitted to perform a requested operation with respect to an asset data structure 160. For example, an owner system policy 132 may indicate conditions upon which an owner system 115 (verified as being the actual owner of the asset data structure 160) is permitted to read or append to the asset data structure 160, access/modify the asset status 138 of the asset data structure 160, transfer ownership of the asset data structure 160, etc. The owner system policy 132 for an asset data structure 160 may, for example, indicate that an owner system 115 of the asset data structure 160 (e.g., as identified by an owner system identifier) is not permitted to change ownership of the asset data structure 160. For example, the GOT application 150 may generate the owner system policies 132 based on asset permission data received in a create new asset data structure request.

The delegate system policies 135 may include instructions (e.g., logic/code) that may be used to define whether a requestor delegate system 118 is permitted to perform a requested operation with respect to an asset data structure 160. For example, a delegate system policy 135 may indicate conditions upon which a delegate system 118 (verified as being the delegate of the asset data structure 160) is permitted to read or append to the asset data structure 160, access/modify the asset status 138 of the asset data structure 160, transfer ownership of the asset data structure 160, etc. The delegate system policy 135 for an asset data structure 160 may, for example, indicate that a delegate system 118 of the asset data structure 160 (e.g., as identified by a delegate system identifier) is only permitted to read asset entries 163 in the asset data structure 160 that the delegate system 118 previously appended to the asset data structure 160 (e.g., as indicated in a transaction receipt), only permitted to read asset entries 163 to the asset data structure 160 when the asset entries 163 relate to events that occurred during a time period when the delegate system 118 was a delegate of the asset data structure 160 (e.g., was in control of or using the physical asset), or only permitted to append asset entries 163 to the asset data structure 160 when the asset entries 160 relate to events that occurred during a time period when the delegate system 118 was a delegate of the asset data structure 160. For example, the GOT application 150 may generate the delegate system policies 135 based on asset permission data received in a create new asset data structure request.

The asset statuses 138 may indicate a current status of each asset data structure 160. For example, a status of an asset data structure 160 may be active (e.g., the owner system 115 and delegate systems 118 may still be accessing the asset data structure 160, and the asset data structure 160 may be still retained), archived (e.g., the owner system 115 and delegate systems 118 may not have accessed the asset data structure 160 for at least a first threshold period of time, and the asset data structure 160 may be still retained—but in a lower cost storage media), deleted (e.g., the owner system 115 and delegate systems 118 may not have accessed the asset data structure 160 for at least a second threshold period of time, and the asset data structure 160 may no longer be stored), forgotten (e.g., the owner system 115 and delegate systems 118 may have been detached from the asset structure 160 by removing the linkage between the owner system 115/delegate systems 118, internal DID 144, and public DID 147 associated with the asset data structure 160), etc.

The internal DIDs 144, public DIDs 147, and group DIDs 149 may each refer to different identifiers associated with a physical asset and the asset data structure 160 (e.g., may be included in service requests to identify the asset data structure 160). The internal DID 144 may refer to a permanent, immutable identifier of the physical asset, defining a permanent identity of the physical asset. The public DID 147 may refer to alias identifiers issued by owners and delegates (in some cases, temporary), which may be used to identify the physical asset in service requests. The group DID 149 may refer to an identifier that can be mapped to multiple different physical assets, for example, based on a shared location of the multiple different physical assets (e.g., multiple physical assets may be in transport on a truck together).

The AIS system 106 may be a collection of hardware and software resources (e.g., distributed or co-located servers with computing and memory resources) with a data store 153 and an AIS application 159. The AIS application 159 may be instructions stored on a memory of the AIS system 106 and executable by a processor of the AIS system 106. The AIS application 159 may receive service requests from various requestors, processes the service requests using the certificate authority system 112 and the GOT system 103, perform permitted operations with respect to the asset data structure 160 indicated in the service requests, add to the system log 156, generate transaction receipts, and transmit responses back to the requestors accordingly. The data store 153 (e.g., one or more memories) may store a system log 156, which may include logs detailing each of the service requests, permissions checks, and operations performed on asset data structures 160 (e.g., with metadata including timestamps, asset entry pointers, etc.).

The certificate authority system 112 may be a collection of hardware and software resources (e.g., distributed or co-located servers with computing and memory resources) with a data store 169 and an authentication application 178. The authentication application 178 may be instructions stored on a memory of the certificate authority system 112 and executable by a processor of the certificate authority system 112. The data store 169 (e.g., one or more memories) may store credentials 170 for verified owner systems 115 and delegate systems 118 that may access the asset data structures 160, if permitted based on the owner system policies 132 and delegate system policies 135. The credentials 170 may include digital signatures 172 and certificates 175. A digital signature 172 may be a cryptographic mechanism that ensures the authenticity, integrity, and non-repudiation of service request received from a requestor using the requestor's private key. A certificate 175 is an electronic document issued by a trusted authority (e.g., the certificate authority system 112) that binds a public key to the identity of the requestor.

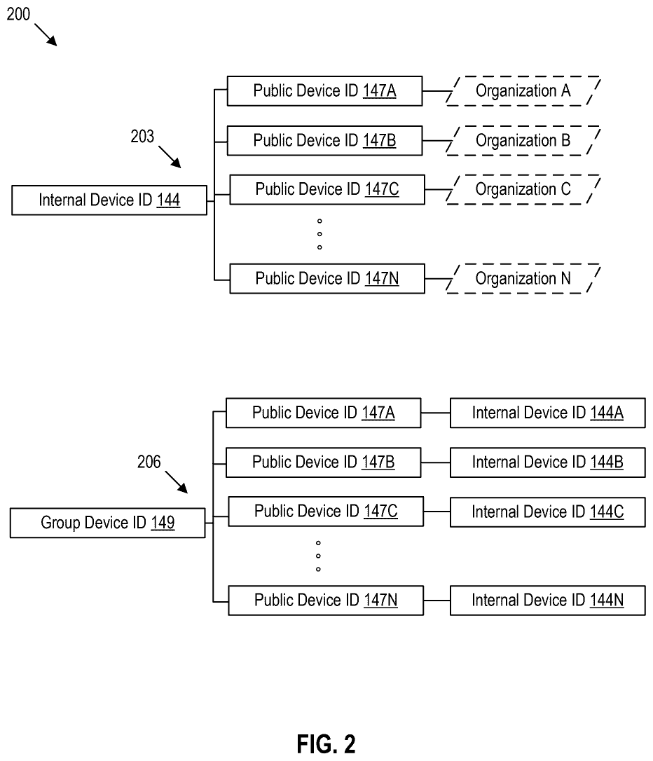

Referring now to FIG. 2, shown is a diagram 200 of various DIDs used by the components of the communication system 100 of FIG. 1 according to various embodiments of the disclosure. FIG. 2 illustrates mappings 203 and 206. Mappings 203 illustrate the associations between an internal DID 144 and multiple public DIDs 147A-N, and mappings 206 illustrate associations between a group DID 149 and public DIDs 147A-N and corresponding internal DIDs 144a-n.

As shown in mappings 203, a single internal DID 144 (e.g., the permanent identifier of an asset, which may be a physical asset or digital asset) may map to multiple public DIDs 147A-N. Each of the public DIDs 147A-N may correspond to different organizations A-N (e.g., different owner systems 115 and/or delegate systems 118). For example, a device may have a single internal DID 144, and each organization A-N may have a different public DID 147A-N to refer to the same device. The public DIDs 147A-N (and in some cases, the internal DID 144) may be included in service requests sent to the AIS system 106 by different requestor systems.

As shown in mappings 206, a single group DID 149 may refer to multiple different assets, each having a different public DID 147A-N. Since the physical assets being included with a group DID 149 may be different, each asset may have a different internal DID 144A-N as well. For example, a shipping truck may be carrying N physical with respective internal DIDs 144A-N and respective public DIDs 147A-N. All of the assets in the shipping truck may be associated with the single group ID 149, which may be used to track information related to the shipping of the assets in the shipping truck (e.g., location data, humidity data, temperature data, etc.).

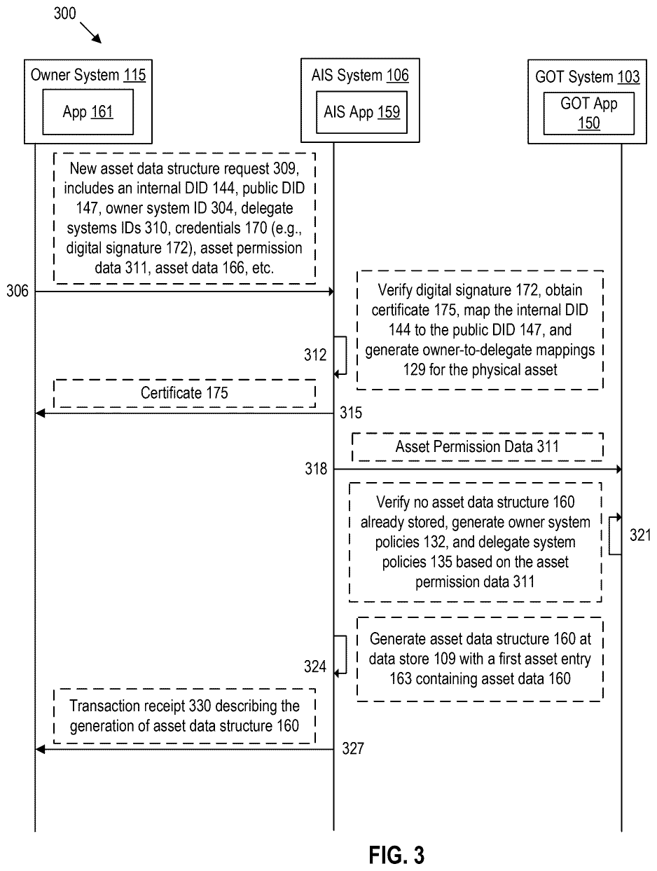

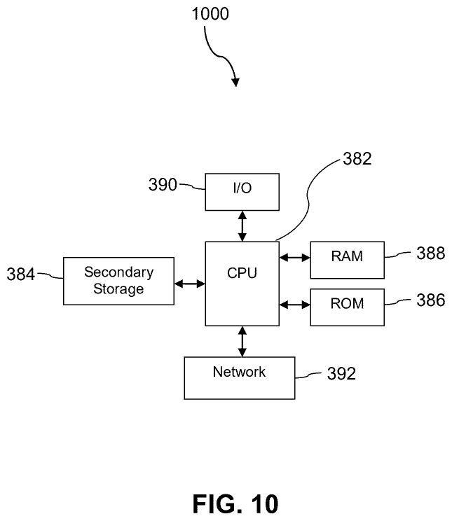

Referring now to FIG. 3, shown is a message sequence diagram illustrating a method 300 of generating a new asset data structure 160 according to various embodiments of the disclosure. The method 300 may be performed by the application 161 at the owner system 115, the AIS application 159 at the AIS system 106, and the GOT application 150 at the GOT system 103. While not shown in FIG. 3, one or more operations of generating a new asset data structure 160 may be performed by other entities (e.g., the certificate authority system 112). In embodiments, the method 300 may be implemented using a computer system with components as shown in FIG. 10. As illustrated, method 300 of FIG. 3 includes a number of enumerated operations, but embodiments of the operations in FIG. 3 may include additional operations before, after, and in between the enumerated operations. In some embodiments, one or more of the enumerated operations may be omitted or performed in a different order.

Method 300 may begin with operation 306, in which the application 161 at the owner system 115 generates and transmits a new asset data structure request 309 to the AIS system 106. The new asset data structure request 309 may include one or more parameters, such as, for example, a DID (e.g., an internal DID 144, public DID 147, and/or group DID 149) of an asset (physical or digital asset) for which to create an asset data structure 160, an owner system identifier 304 identifying the owner system 115, one or more delegate system identifiers 310 identifying one or more delegate systems 118 or delegates that may temporary use/control the asset and access the asset data structure 160 (as permitted), credentials of the owner system 115 (e.g., a digital signature 172), asset permission data 311, asset data 166 to add to the asset data structure 160, and/or a description of the asset. The asset permission data 311 may indicate, for example, operations that may be permitted to be performed and/or prohibited from being performed by owner systems and delegate systems (e.g., certain delegate systems may only be permitted to read asset entries that were added to the asset data structure by the respective delegate systems, certain delegate systems may be prohibited from appending to the asset data structure, etc.). For example, the asset permission data 311 may list the permissions and prohibitions for different owner systems 115 and delegate systems 118 (e.g., using owner system identifiers 304 and delegate system identifiers 310).

The AIS application 159 may receive the new asset data structure request 309. At operation 312, the AIS application 159 may first verify the digital signature 172 (e.g., using the authentication application 178 at the certificate authority system 112 based on the digital signatures 172 of authorized requestors saved at the certificate authority system 112). The AIS application 159 may also verify that the owner system identifier 304 received in the request 309 matches the identification data of the current owner system 115 of the asset, as stored in the asset ownership data 141 at the GOT system 103 (e.g., by requesting the asset ownership data 141 for the asset from the GOT system 103). The AIS application 159 may also map the internal DID 144 of the asset to the public DID 147 (and/or group DID 149), and then indicate that the public DID 147 is the identifier of the asset as used by the owner system 115. The AIS application 159 may also generate owner-to-delegate mappings 129 to map the delegate systems 118 identified in the request 309 to the owner system 115 and the asset data structure 160 and/or asset (e.g., based on the owner system identifier 304 and delegate system identifiers 310 received in the request 309).

The AIS application 159 at the AIS system 106 may communicate with the authentication application 178 at the certificate authority system 112 to generate a certificate 175 for the owner system 115 and store the certificate 175 in association with the owner system identifier 304 (e.g., based on the verification of the digital signature 172). At operation, the AIS application 159 may transmit the certificate 175 to the owner system 115 for subsequent use as a credential 170.

At operation 318, the AIS application 159 may transmit the asset permission data 311 received in the request 309 to the GOT system 103. The GOT application 150 may then perform operation 321 to verify that an asset data structure 160 does not already exist for the asset described in the new asset data structure request 309. For example, the GOT application 150 may verify that an asset data structure 160 of the same name (or otherwise associated with the asset) is not already stored in the data store 109. At operation 321, the GOT application 150 may also generate owner-to-delegate mappings 129, owner system policies 132, and delegate system policies 135 based on the parameters received in the request 309. The AIS application 159 may use the asset permission data 311 received in the request 309 to generate the conditional logic/code of the owner system policies 132 and the delegate system policies 135. For example, when the asset permission data 311 indicates that a particular delegate system 118 is not permitted to read asset entries 163 in the asset data structure 160 pertaining to events/data that are associated with different delegate systems 118, the GOT application 150 may generate a delegate system policy 135 indicating that the delegate system 118 (identified by a delegate system identifier 310) is only permitted to read asset entries 163 from the asset data structure 160 associated with events/data that occurred during a time period in which the delegate system 118 was a delegate of the asset (e.g., as indicated in the time period-to-organization mapping 126).

At operation 324, the AIS application 159 at the AIS system 106 may generate the asset data structure 160 at the data store 109. The AIS application 159 may add a first asset entry 163 to the asset data structure 160, in which the first asset entry 163 contains asset data 166 (e.g., as received in the request 309) and/or metadata related to the creation of the asset data structure 160 (e.g., data from the request 309, timestamp of creation, etc.). The AIS application 159 may also update the system log 156 with similar data based on the newly created asset data structure 160. At operation 327, the AIS application 159 may generate and transmit a transaction receipt 330 describing the generation of the asset data structure 160. The transaction receipt 330 may include data from the request 309, the applicable owner system policies 132 and delegate system policies 135, timestamp of generation of the asset data structure 160, location of storage of the asset data structure 160, data describing the asset, etc.

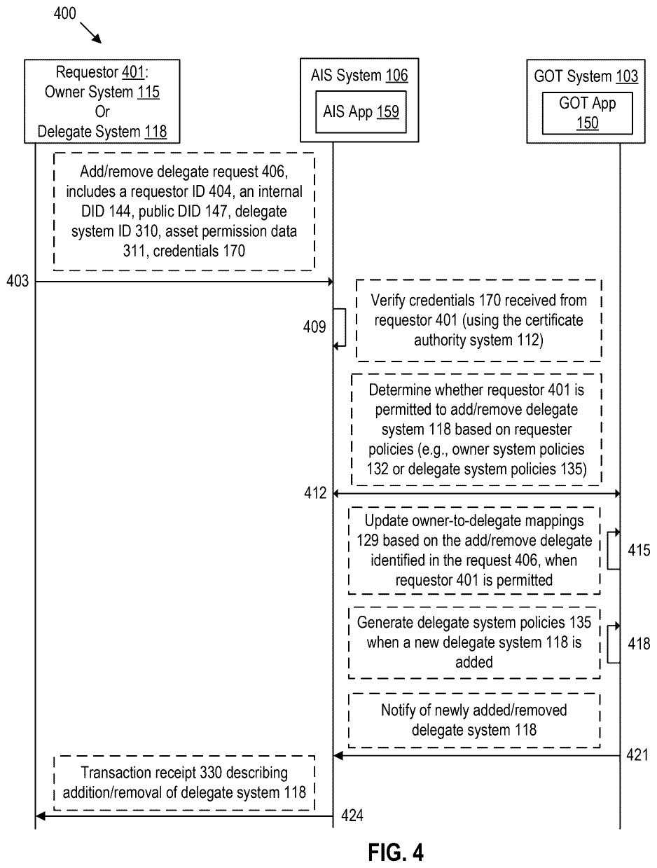

Referring now to FIG. 4, shown is a message sequence diagram illustrating a method 400 of adding or removing a new delegate of an asset data structure 160 according to various embodiments of the disclosure. The method 400 may be performed by a requestor 401 (e.g., an owner system 115, delegate system 118, or other system), the AIS application 159 at the AIS system 106, and the GOT application 150 at the GOT system 103. While not shown in FIG. 4, one or more operations of adding or removing a new delegate of an asset data structure 160 may be performed by other entities (e.g., the certificate authority system 112). In embodiments, the method 400 may be implemented using a computer system with components as shown in FIG. 10. As illustrated, method 400 of FIG. 4 includes a number of enumerated operations, but embodiments of the operations in FIG. 4 may include additional operations before, after, and in between the enumerated operations. In some embodiments, one or more of the enumerated operations may be omitted or performed in a different order.

At operation 403, the requestor 401 (e.g., the application 161 at the owner system 115 or the application 162 at the delegate system 118) may generate an add/remove delegate request 406. The add/remove delegate request 406 may be a request to add or remove a delegate system 118 (and thus, corresponding delegate organization) from a list of authorized delegates of the asset data structure 160 (e.g., as indicated in the owner-to-delegate mapping 129 of the asset data structure 160). The add/remove delegate request 406 may include one or more parameters, such as, for example, a requestor identifier 404 (e.g., an owner system identifier 304, a delegate system identifier 310, or identifier of other requestor 401 system), a DID of the asset associated with the asset data structure 160 (e.g., the internal DID 144, public DID 147, and/or group DID 149), one or more delegate system identifiers 310 and associated time periods that the delegate uses/controls the asset, asset permission data 311 for newly added delegates, and/or credentials 170 of the requestor 401.

The AIS application 159 at the AIS system 106 may receive the add/remove delegate request 406, and then perform operation 409. At operation 409, the AIS application 159 may verify the credentials 170 received from the requestor 401 (e.g., by checking the received credentials 170 against credentials stored at the certificate authority system 112) to validate the identity of the requestor 401. At operation 412, the AIS application 159 may pass the requestor identifier 404 identifying the requestor 401 to the GOT system 103 such that the GOT application 150 may determine whether the requestor 401 is permitted to add/remove the delegate system 118 identified in the request 406 based on requestor policies. The requestor policies may be owner system policies 132 or delegate system policies 135 based on whether the requestor 401 is the owner system 115 of the asset data structure 160 or a delegate system 118 of the asset data structure 160 (e.g., each policy 132/135 may be associated with an owner system identifier 304 or a delegate system identifier 310, and a requestor identifier may be matched against an owner system identifier 304 or delegate system identifier 310 to identify the corresponding policy 132/135).

When the requestor 401 is permitted to add or remove delegates for the asset data structure 160, the GOT application 150 may perform operation 415 to update the owner-to-delegate mappings 129 of the asset data structure 160 to add or remove the delegate system 118 (e.g., add or remove the delegate identifier 310) identified in the request 406. For example, when the requestor 401 is permitted to remove delegates, the GOT application 150 may update the owner-to-delegate mappings 129 of the asset data structure 160 to remove the delegate system 118 (e.g., the delegate identifier 310) identified in the request 406. When the requestor 401 is permitted to add delegates, the GOT application 150 may update the owner-to-delegate mappings 129 of the asset data structure 160 to add the delegate system 118 (the delegate identifier 310) identified in the request 406. In this case, the GOT application 150 may perform operation 418 to generate new delegate system policies 135 for the new delegate system 118 added for the asset data structure 160 based on the asset permission data 311 received in the request 406.

At operation 421, the GOT application 150 may notify the AIS system 106 of the newly added/removed delegate system 118. The notification may be in the form of a message sent by the GOT application 150 to the AIS system 106, which may include, for example, the updated owner-to-delegate mappings 129 for the asset data structure 160, the timestamp of updating the owner-to-delegate mappings 129, the timestamp of generating the new delegate system policies 135, data describing the newly generated delegate system policies 135, etc. The AIS application 159 may then update the system log 156 with similar information indicative of the newly added/removed delegate system 118 for the asset data structure 160. At operation 424, the AIS application 159 of the AIS system 106 may generate and transmit a transaction receipt 330 describing the addition or removal of the delegate system 118 with respect to the asset data structure 160 to the requestor 401. The transaction receipt 330 may include, for example, data from the request 406, the requestor identifier 404, the DIDs, the asset permission data 311, the updated owner-to-delegate mappings 129 for the asset data structure 160, the timestamp of updating the owner-to-delegate mappings 129, the timestamp of generating the new delegate system policies 135, data describing the newly generated delegate system policies 135, etc.

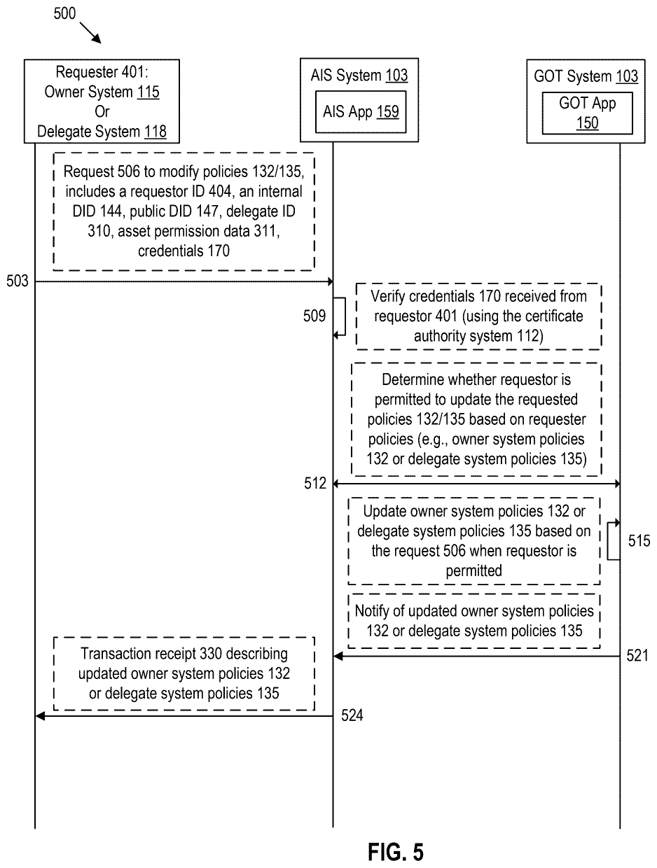

Referring now to FIG. 5, shown is a message sequence diagram illustrating a method 500 of modifying policies according to various embodiments of the disclosure. The method 500 may be performed by a requestor 401 (e.g., an owner system 115, delegate system 118, or other system), the AIS application 159 at the AIS system 106, and the GOT application 150 at the GOT system 103. While not shown in FIG. 5, one or more operations of modifying policies may be performed by other entities (e.g., the certificate authority system 112). In embodiments, the method 500 may be implemented using a computer system with components as shown in FIG. 10. As illustrated, method 500 of FIG. 5 includes a number of enumerated operations, but embodiments of the operations in FIG. 5 may include additional operations before, after, and in between the enumerated operations. In some embodiments, one or more of the enumerated operations may be omitted or performed in a different order.

At operation 503, the requestor 401 (e.g., the application 161 at the owner system 115 or the application 162 at the delegate system 118) may generate a request 506 to modify an owner system policy 132 and/or delegate system policy 134. The request 506 may include one or more parameters, such as, for example, a request identifier 404 (e.g., an owner system identifier 304, a delegate system identifier 310, or identifier of other requestor 401 system), an DID associated with the asset data structure 160 (internal DID 144, public DID 147, and/or group DID 149), one or more delegate system identifiers 310 for which the delegate system policy 135 is to be modified, asset permission data 311 specifying modifications to the owner system policy 132 and/or delegate system policies 135, and/or credentials 170 of the requestor 401.

The AIS application 159 at the AIS system 106 may receive the request 506, and then perform operation 509. At operation 509, the AIS application 159 may verify the credentials 170 received from the requestor 401 (e.g., by checking the received credentials 170 against credentials stored at the certificate authority system 112) to validate the identity of the requestor 401. At operation 512, the AIS application 159 may pass the requestor identifier 404 identifying the requestor 401 to the GOT system 103 such that the GOT application 150 may determine whether the requestor 401 is permitted to update the requested owner system policies 132 and/or delegate system policies 135 based on requestor policies. The requestor policies may be owner system policies 132 or delegate system policies 135 based on whether the requestor 401 is the owner system 115 of the asset data structure 160 or a delegate system 118 of the asset data structure 160 (e.g., each policy 132/135 may be associated with an owner system identifier 304 and a delegate system identifier 310, and a requestor identifier may be matched against an owner system identifier 304 or delegate system identifier 310 to identify the corresponding policy 132/135).

When the requestor 401 is permitted to modify owner system policies 132 and/or delegate system policies 135 associated with an asset data structure 160, the GOT application 150 performS operation 515 to modify the owner system policies 132 and/or delegate system policies 135 based on the delegate system identifiers 310 and asset permission data 311 carried in the request. For example, when the requestor 401 is permitted to modify/update an owner system policy 132 (e.g., because the requestor 401 is the owner system 115 of the asset data structure 160), the GOT application 150 may update the owner system policy 132 based on the asset permission data 311. When the requestor 401 is permitted to modify/update a delegate system policy 135 (e.g., because the requestor 401 is the owner system 115 of the asset data structure 160), the GOT application 150 may update the delegate system policy 135 (e.g., as identified by the delegate identifier 310 in the request 506) based on the asset permission data 311.

At operation 521, the GOT application 150 may notify the AIS system 106 of the updated owner system policies 132 and/or delegate system policies 135. The notification may be in the form of a message sent by the GOT application 150 to the AIS system 106, which may include, for example, the update to the owner system policies 132 and/or delegate system policies 135, the asset permission data 311, the timestamp of updating the owner system policies 132 and/or delegate system policies 135, etc. The AIS application 159 may update the system log 156 to include similar information to describe the modified owner system policies 132 and/or delegate system policies 135. At operation 524, the AIS application 159 of the AIS system 106 may generate and transmit a transaction receipt 330 describing the updated owner system policies 132 and/or delegate system policies 135 to the requestor 401. The transaction receipt 330 may include, for example, data from the request 506, the requestor identifier 404, the DIDs, the asset permission data 311, the updated owner system policies 132 and/or delegate system policies 135, the timestamp of updating the owner system policies 132 and/or delegate system policies 135, etc.

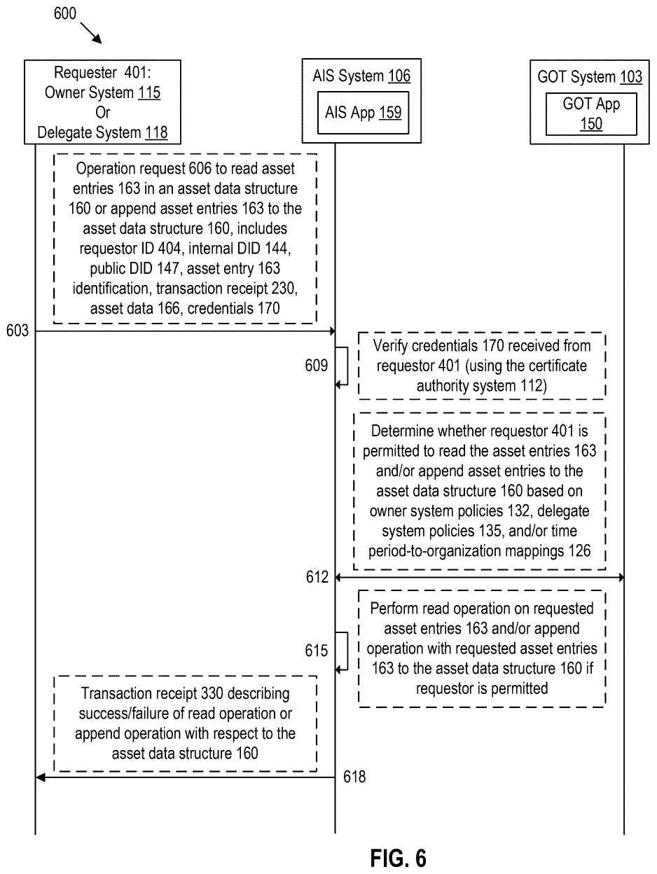

Referring now to FIG. 6, shown is a message sequence diagram illustrating a method 600 of performing a requested operation with respect to the asset data structure 160 according to various embodiments of the disclosure. The method 600 may be performed by a requestor 401 (e.g., an owner system 115, delegate system 118, or other system), the AIS application 159 at the AIS system 106, and the GOT application 150 at the GOT system 103. While not shown in FIG. 6, one or more operations of performing a requested operation with respect to the asset data structure 160 may be performed by other entities (e.g., the certificate authority system 112). In embodiments, the method 600 may be implemented using a computer system with components as shown in FIG. 10. As illustrated, method 600 of FIG. 6 includes a number of enumerated operations, but embodiments of the operations in FIG. 6 may include additional operations before, after, and in between the enumerated operations. In some embodiments, one or more of the enumerated operations may be omitted or performed in a different order.

At operation 603, the requestor 401 (e.g., the application 161 at the owner system 115 or the application 162 at the delegate system 118) may generate an operation request 606 to read one or more asset entries 163 in an asset data structure 160 and/or append one or more asset entries 163 to the asset data structure 160. The operation request 606 may include one or more parameters, such as, for example, a request identifier 404 (e.g., an owner system identifier, a delegate system identifier, or identifier of other requestor 401 system), a DID associated with the asset (e.g., internal DID 144, public DID 147, and/or group DID 149), an identification of an asset entry 163 to read, a prior transaction receipt 330 indicating an asset entry 163, asset data 166 to append to the asset data structure 160, and/or credentials 170 of the requestor 401.

The AIS application 159 at the AIS system 106 may receive the operation request 606, and then perform operation 609. At operation 609, the AIS application 159 may verify the credentials 170 received from the requestor 401 (e.g., by checking the received credentials 170 against credentials stored at the certificate authority system 112) to validate the identity of the requestor 401. At operation 612, the AIS application 159 may pass the requestor identifier 404 identifying the requestor 401 to the GOT system 103 such that the GOT application 150 may determine whether the requestor 401 is permitted to perform the requested operated (i.e., the read or append operation) indicated in the operation request 606. That is, the GOT application 150 may determine whether the requestor 401 permitted to read asset entries 163 in the asset data structure 160 and/or append asset entries 163 to the asset data structure 160 based on requestor policies and/or time period-to-organization mappings 126. The requestor policies may be owner system policies 132 or delegate system policies 135 based on whether the requestor 401 is the owner system 115 of the asset data structure 160 or a delegate system 118 of the asset data structure 160 (e.g., each policy 132/135 may be associated with an owner system identifier 304 and a delegate system identifier 310, and a requestor identifier 404 may be matched against an owner system identifier 304 or delegate system identifier 310 to identify the corresponding policy 132/135).

The time period-to-organization mappings 126 may indicate time periods in which the requestor 401 may have been using/controlling the asset so as to add asset data 166 to the asset data structure 160 or read asset data 166 from the asset data structure 160 during those time periods. For example, the time period-to-organization mappings 126 may include the requestor identifier 404 (which may be an owner system identifier 304 or delegate system identifier 310) and the associated time periods. For example, a requestor policy may indicate that only data that was previously appended to the asset data structure 160 by the requestor 401 may be subsequently read by the requestor 401 (as evidenced by the prior transaction receipt 330 that may be carried in the operation request 606). The GOT application 150 may use the prior transaction receipt 330, the time period-to-organization mappings 126, and the requestor policy to determine whether the requestor 401 is permitted to read an asset entry 163 specified in the operation request 606 or the prior transaction receipt 330.

At operation 615, when the requestor 401 is permitted to perform the requested operation with respect to the asset data structure 160, the AIS application 159 at the AIS system 106 may perform the requested operation with respect to the asset data structure 160 (e.g., the AIS application 159 may perform a read operation on the requested asset entries 163 and/or append the requested asset entries 163 to the asset data structure 160, if permitted). The AIS application 159 may update the system log 156 with, for example, data from the operation request 606, data describing the access owner system policies 132 and/or delegate system policies 135, and/or data describing the performance of the requested operation (e.g., success/failure, timestamps, etc.).

At operation 618, the AIS application 159 of the AIS system 106 may generate and transmit a transaction receipt 330 describing the operation request 606, the accessed owner system policies 132 and/or delegate system policies 135, and/or data describing the performance of the requested operation (e.g., success/failure, timestamps, etc.). The transaction receipt 330 may include, for example, data from the operation request 606, the requested operation data, the requestor identifier 404, the DIDs, the accessed owner system policies 132 and/or delegate system policies 135, the timestamp of performing the requested operation, etc.

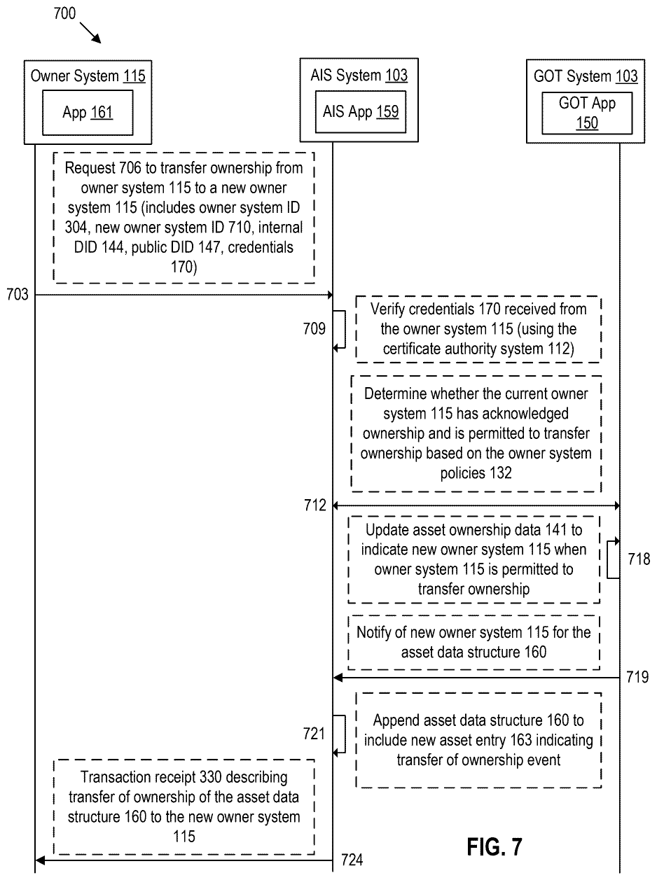

Referring now to FIG. 7, shown is a message sequence diagram illustrating a method 700 of transferring ownership of an asset data structure 160 to a new owner system 115. The method 700 may be performed by current owner system 115, the AIS application 159 at the AIS system 106, and the GOT application 150 at the GOT system 103. While not shown in FIG. 7, one or more operations of transferring ownership of an asset data structure 160 to a new owner system 115 may be performed by other entities (e.g., the certificate authority system 112). In embodiments, the method 700 may be implemented using a computer system with components as shown in FIG. 10. As illustrated, method 700 of FIG. 7 includes a number of enumerated operations, but embodiments of the operations in FIG. 7 may include additional operations before, after, and in between the enumerated operations. In some embodiments, one or more of the enumerated operations may be omitted or performed in a different order.

At operation 703, the current owner system 115 may generate a request 706 to transfer ownership of the asset data structure 160 to a new owner system 115. The request 706 may include one or more parameters, such as, for example, an owner system identifier 304 of the current owner system 115, a new owner system identifier 710 of the new owner system 115, a DID associated with the physical asset (e.g., the internal DID 144, public DID 147, and/or group DID 149), and/or credentials 170 of the current owner system 115.

The AIS application 159 at the AIS system 106 may receive the request 706, and then perform operation 709. At operation 709, the AIS application 159 may verify the credentials 170 received from the requestor 401 (e.g., by checking the received credentials 170 against credentials stored at the certificate authority system 112) to validate the identity of the requestor 401.

At operation 712, the AIS application 159 may pass the owner system identifier 304 identifying the current owner system 115 to the GOT system 103 such that the GOT application 150 may determine whether the current owner system 115 has acknowledged ownership of the asset data structure 160 and is indeed the current owner of the asset data structure 160. This determination may be performed using the asset ownership data 141 stored at the GOT system 103. The GOT application 150 may also determine whether the current owner system 115 is permitted to transfer ownership based on the owner system policies 132 associated with the asset data structure 160 and/or the current owner system 115. For example, the owner system policy 132 may indicate that the current owner system 115 is not permitted to transfer ownership of the asset data structure 160 (perhaps because the physical asset is not permitted to transfer ownership as well), in which case method 700 would not proceed with the remaining steps, but instead may include sending an error message to the current owner system 115. On the other hand, when the owner system policy 132 indicates that the owner system 115 is permitted to transfer ownership, in some cases, only to certain types of new owner systems 115 (and the new owner system 115 identified in the request 706 is the permitted type of new owner system 115), method 700 may proceed to operation 718.

At operation 718, the GOT application 150 may update the asset ownership data 141 to indicate the new owner system 115 when the current owner system 115 is permitted to transfer ownership according to the owner system policy 132. For example, the GOT application 150 may add to, replace, or append the asset ownership data 141 to indicate that the current owner of the asset data structure 160 (and the corresponding physical asset) is changing from the current owner system 115 to the new owner system 115 (corresponding to a different organization). In this way, the asset ownership data 141 may include data indicative of which owner system 115 (and owner organization) owns the asset data structure 160 (and corresponding physical asset) and a time period of owning the asset data structure 160.

At operation 719, the GOT application 150 may notify the AIS system 106 of the new owner system 115 for the asset data structure 160. The notification may be in the form of a message sent by the GOT application 150 to the AIS system 106, which may include, for example, the current owner system identifier 304, the new owner system identifier 710, the applicable DID (e.g., internal DID 144, public DID 147, and/or group DID 149), a timestamp of updating the owner system 115 of the asset data structure 160, etc. At operation 721, the AIS application 159 of the AIS system 106 may append the asset data structure 160 to include a new asset entry 163 indicating the transfer of ownership from the current owner system 115 to the new owner system 115 (i.e., describing the transfer of ownership event to the new owner system 115). The new asset entry 163 may include the new owner system identifier 710 and an indication (e.g., flag) that ownership of the asset data structure 160 has transferred.

At operation 724, the AIS application 159 may generate and transmit a transaction receipt 330 describing the transfer of ownership from the current owner system 115 to the new owner system 115. The transaction receipt 330 may include, for example, data from the request 706, the current owner system identifier 304, the new owner system identifier 710, the applicable DID (e.g., internal DID 144, public DID 147, and/or group DID 149), a timestamp of updating the owner system 115 of the asset data structure 160, etc.

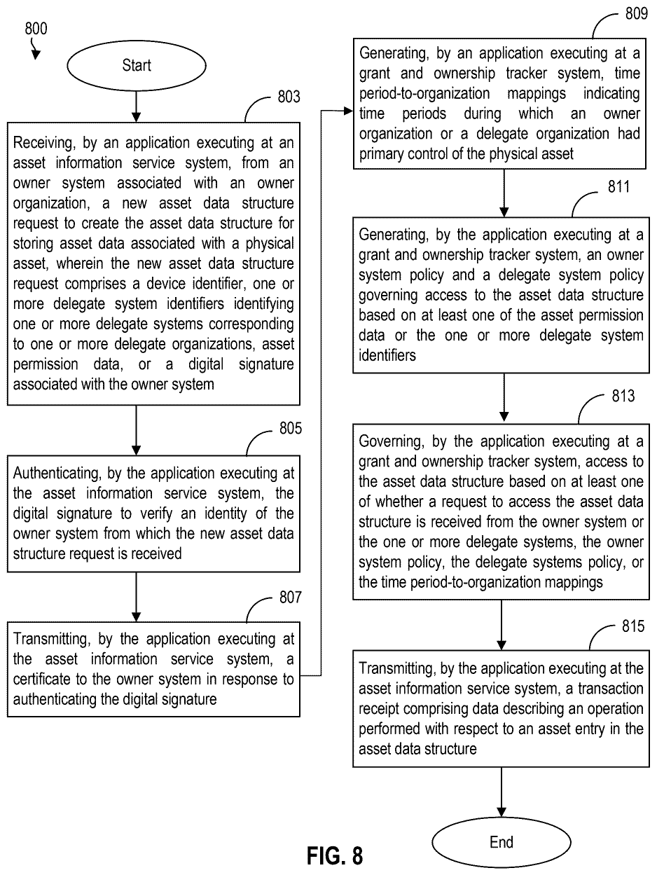

Referring now to FIG. 8, shown is a method 800 of asset tracking and governing access to the asset tracking according to various embodiments of the disclosure. Method 800 may be performed by a requestor 401 (e.g., an owner system 115, delegate system 118, or other system), the AIS application 159 at the AIS system 106, and the GOT application 150 at the GOT system 103. In embodiments, the method 800 may be implemented using a computer system with components as shown in FIG. 10. As illustrated, method 800 of FIG. 8 includes a number of enumerated operations, but embodiments of the operations in FIG. 8 may include additional operations before, after, and in between the enumerated operations. In some embodiments, one or more of the enumerated operations may be omitted or performed in a different order.

At step 803, method 800 comprises receiving, by an application (e.g., AIS application 159) executing at the AIS system 106, from an owner system 115 associated with an owner organization, a new asset data structure request 309 to create the asset data structure 160 for storing asset data 166 associated with a physical asset. In an embodiment, the new asset data structure request 309 comprises at least one of a device identifier (e.g., internal DID 144, public DID 147, and/or group DID 149), one or more delegate system identifiers 310 identifying one or more delegate systems 118 corresponding to one or more delegate organizations, asset permission data 311, or a digital signature 172 associated with the owner system 115.

At step 805, method 800 comprises authenticating, by the application (e.g., AIS application 159) executing at the AIS system 106, the digital signature 172 to verify an identity of the owner system 115 from which the new asset data structure request 309 is received. At step 807, method 800 comprises transmitting, by the application (e.g., AIS application 159) executing at the AIS system 106, a certificate 175 to the owner system 115 in response to authenticating the digital signature 172. At step 809, method 800 comprises generating, by an application (e.g., GOT application 150) executing at a GOT system 103, time period-to-organization mappings 126 indicating time periods during which an owner organization or a delegate organization had primary control of the physical asset. At step 811, method 800 comprises generating, by the application (e.g., GOT application 150) executing at a GOT system 103, an owner system policy 132 and a delegate system policy 135 governing access to the asset data structure 160 based on at least one of the asset permission data 311 or the one or more delegate system identifiers 310.

At step 813, method 800 comprises governing, by the application (e.g., GOT application 150) executing at a GOT system 103, access to the asset data structure 160 based on at least one of whether a request (e.g. operation request 606) to access the asset data structure 160 is received from the owner system 115 or the one or more delegate systems 118, the owner system policy 132, the delegate systems policy 135, or the time period-to-organization mappings 126. At step 815, method 800 comprises transmitting, by the application (e.g., AIS application 159) executing at the AIS system 106, a transaction receipt 330 comprising data an operation performed with respect to an asset entry 163 in the asset data structure 160.

Method 800 may include other steps and/or features that are not otherwise shown in FIG. 8. In an embodiment, the asset data 166 comprises data received from a radio frequency identification (RFID) card attached to the physical asset or attached to a packaging of the physical asset. In an embodiment, method 800 may further comprise receiving, by the application (e.g., GOT application 150) executing at a GOT system 103, the request (e.g., operation request 606) to read the asset entry 163 of the asset data structure 160 from a delegate system 118, the request may comprise the transaction receipt 330 indicating that the delegate system 118 appended the asset entry 163 to the asset data structure 160 at a prior time, determining, by the application (e.g., GOT application 150) executing at a GOT system 103, that the delegate system 118 has permission to read the asset entry 163 based on the delegate system policy 135 associated with the delegate system 118 and the transaction receipt 330 indicating that the asset entry 163 originated with the delegate system 118, performing, by the application (e.g., application 159) executing at the AIS system 106, a read operation on the asset data structure 160 to read asset data 166 from the asset entry 163, and transmitting, by the application (e.g., application 159) executing at the AIS system 106, the asset data 166 from the asset entry 163 to the delegate system 118.

In an embodiment, method 800 may further comprise receiving, by the application (e.g., GOT application 150) executing at a GOT system 103, the request (e.g., operation request 606) to append the asset entry 163 to the asset data structure 160 from a delegate system 118, determining, by the application (e.g., GOT application 150) executing at a GOT system 103, that the delegate system 118 has permission to append the asset entry 163 to the asset data structure 160 based on the delegate system policy 135 associated with the delegate system 118 and the time period-to-organization mappings 126 indicating that a time of an event described in the asset entry 163 corresponds to a time period in which the delegate system 118 had primary control of the physical asset, performing, by the application (e.g., application 159) executing at the AIS system 106, an append operation on the asset data structure 160 to append the asset entry 163 to the asset data structure 160, and transmitting, by the application (e.g., application 159) executing at the AIS system 106, a second transaction receipt 330 to the delegate system 118 indicating that the asset entry 163 was successfully appended to the asset data structure 160 and a timestamp of appending the asset entry 163 to the asset data structure 160. In an embodiment, method 800 may further comprise receiving, by the application (e.g., GOT application 150) executing at a GOT system 103, an asset status request for a status of the asset data structure 160 from a delegate system 118, determining, by the application (e.g., GOT application 150) executing at a GOT system 103, whether the delegate system 118 has permission to access a status of the asset data structure 160, and transmitting, by the application (e.g., GOT application 150) executing at a GOT system 103, the status of the asset data structure 160 to the delegate system 118 in response to determining that the delegate system 118 has permission to access the status, in which the status indicates whether the asset data structure 160 is active or archived.

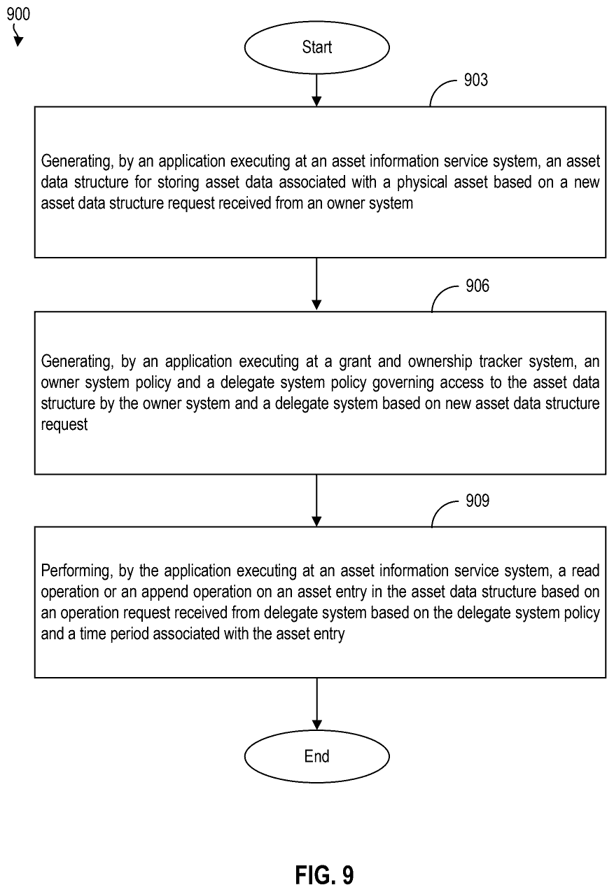

Referring now to FIG. 9, shown is a method 900 of asset tracking and governing access to the asset tracking according to various embodiments of the disclosure. Method 900 may be performed by a requestor 401 (e.g., an owner system 115, delegate system 118, or other system), the AIS application 159 at the AIS system 106, and the GOT application 150 at the GOT system 103. In embodiments, the method 900 may be implemented using a computer system with components as shown in FIG. 10. As illustrated, method 900 of FIG. 9 includes a number of enumerated operations, but embodiments of the operations in FIG. 9 may include additional operations before, after, and in between the enumerated operations. In some embodiments, one or more of the enumerated operations may be omitted or performed in a different order.

At step 903, method 900 comprises generating, by an application (e.g., application 159) executing at an AIS system 106, an asset data structure 160 for storing asset data 166 associated with a physical asset based on a new asset data structure request 309 received from an owner system 115. At step 906, method 900 comprises generating, by an application (e.g., application 150) executing at a GOT system 103, an owner system policy 132 and a delegate system policy 135 governing access to the asset data structure by the owner system and a delegate system based on new asset data structure request 309. At step 909, method 900 comprises performing, by the application (e.g., application 159) executing at an AIS system 106, a read operation or an append operation on an asset entry 163 in the asset data structure 160 based on an operation request 606 received from delegate system 118 based on the delegate system policy 135 and a time period associated with the asset entry 163.

Method 900 may include other steps and/or features that are not otherwise shown in FIG. 9. In an embodiment, the new asset data structure request 309 comprises at least one of a device identifier (e.g., internal DID 144, public DID 147, and/or group DID 149), one or more delegate system identifiers 310 identifying one or more delegate systems 118 corresponding to one or more delegate organizations, asset permission data 311, or a digital signature 172 associated with the owner system 115. In an embodiment, the owner system policy 132 and the one or more delegate system policies 135 are based on asset permission data 311 received in the new asset data structure request 309. In an embodiment, the delegate system policy 135 indicates that the delegate system 118 is permitted to perform the read operation or the append operation on the asset entry 163 when the time period associated with the asset entry 163 is a time during which a delegate organization associated with the delegate system 118 had primary control of the physical asset.

In an embodiment, the operation request 606 comprises a transaction receipt 330 indicating that the asset entry 163 was previously appended to the asset data structure 160 based on a prior operation request 606 received from the delegate system 118, and method 900 may further comprise determining, by the application (e.g., application 150) executing at the GOT system 103, that the read operation is permitted to be performed on the asset entry based on the transaction receipt 330. In an embodiment, method 900 may further comprise transmitting, by the application (e.g., application 159) executing at an AIS system 106, the asset data 166 from the asset entry 163. In an embodiment, method 900 may further comprise determining, by the application (e.g., application 150) executing at the GOT system 103, whether the delegate system 118 is permitted to perform the read operation or the append operation with respect to the asset entry 163 of the asset data structure 160.

FIG. 10 illustrates a computer system 1000 suitable for implementing one or more embodiments disclosed herein. In an embodiment, the GOT system 103, AIS system 106, certificate authority system 112, owner system 115, delegate system 118, and/or asset data store 109 may each be implemented as the computer system 1000. The computer system 1000 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 1000, at least one of the CPU 382, the RAM 388, and the ROM 386 are changed, transforming the computer system 1000 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 1000 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 1000 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 1000 to provide the functionality of a number of servers that is not directly bound to the number of computers in the computer system 1000. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 1000, at least portions of the contents of the computer program product to the secondary storage 384, to the ROM 386, to the RAM 388, and/or to other non-volatile memory and volatile memory of the computer system 1000. The processor 382 may process the executable instructions and/or data structures in part by directly accessing the computer program product, for example by reading from a CD-ROM disk inserted into a disk drive peripheral of the computer system 1000. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 1000.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 1000 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method implemented in a communication network to perform physical asset tracking using an asset data structure and to control access to the asset data structure, wherein the method comprises:
receiving, by an application executing at an asset information service system, from an owner system associated with an owner organization, a new asset data structure request to create the asset data structure for storing asset data associated with a physical asset, wherein the new asset data structure request comprises a device identifier, one or more delegate system identifiers identifying one or more delegate systems corresponding to one or more delegate organizations, asset permission data, or a digital signature associated with the owner system;
authenticating, by the application executing at the asset information service system, the digital signature to verify an identity of the owner system from which the new asset data structure request is received;
transmitting, by the application executing at the asset information service system, a certificate to the owner system in response to authenticating the digital signature;
generating, by an application executing at a grant and ownership tracker system, time period-to-organization mappings indicating time periods during which an owner organization or a delegate organization had primary control of the physical asset;
generating, by the application executing at a grant and ownership tracker system, an owner system policy and a delegate system policy governing access to the asset data structure based on at least one of the asset permission data or the one or more delegate system identifiers;
governing, by the application executing at a grant and ownership tracker system, access to the asset data structure based on at least one of whether a request to access the asset data structure is received from the owner system or the one or more delegate systems, the owner system policy, the delegate systems policy, or the time period-to-organization mappings; and
transmitting, by the application executing at the asset information service system, a transaction receipt comprising data describing an operation performed with respect to an asset entry in the asset data structure.

2. The method of claim 1, wherein the asset data comprises data received from a radio frequency identification (RFID) card attached to the physical asset or attached to a packaging of the physical asset.

3. The method of claim 1, further comprising:
receiving, by the application executing at a grant and ownership tracker system, a request to read the asset entry of the asset data structure from a delegate system, wherein the request comprises the transaction receipt indicating that the delegate system appended the asset entry to the asset data structure at a prior time;
determining, by the application executing at a grant and ownership tracker system, that the delegate system has permission to read the asset entry based on the delegate system policy associated with the delegate system and the transaction receipt indicating that the asset entry originated with the delegate system;
performing, by the application executing at the asset information service system, a read operation on the asset data structure to read asset data from the asset entry; and
transmitting, by the application executing at the asset information service system, the asset data from the asset entry to the delegate system.

4. The method of claim 1, further comprising:
receiving, by the application executing at a grant and ownership tracker system, the request to append the asset entry to the asset data structure from a delegate system;
determining, by the application executing at a grant and ownership tracker system, that the delegate system has permission to append the asset entry to the asset data structure based on the delegate system policy associated with the delegate system and the time period-to-organization mappings indicating that a time of an event described in the asset entry corresponds to a time period in which the delegate system had primary control of the physical asset;
performing, by the application executing at the asset information service system, an append operation on the asset data structure to append the asset entry to the asset data structure; and
transmitting, by the application executing at the asset information service system, a second transaction receipt to the delegate system, wherein the second transaction receipt indicates that the asset entry was successfully appended to the asset data structure and a timestamp of appending the asset entry to the asset data structure.

5. The method of claim 1, further comprising:
receiving, by the application executing at a grant and ownership tracker system, an asset status request for a status of the asset data structure from a delegate system;
determining, by the application executing at a grant and ownership tracker system, whether the delegate system has permission to access a status of the asset data structure; and
transmitting, by the application executing at a grant and ownership tracker system, the status of the asset data structure to the delegate system in response to determining that the delegate system has permission to access the status, wherein the status indicates whether the asset data structure is active or archived.

6. A system, comprising:
an asset information service system comprising:
a first memory;
a first processor; and
a first application stored at the first memory and executable by the first processor, which when executed by the first processor, causes the first application to be configured to:
receive, from a requestor, a request to perform an operation with respect to an asset entry in an asset data structure that stores asset data associated with a physical asset, wherein the request includes credentials, a device identifier identifying the physical asset, and operation data describing the operation to be performed on the asset data structure; and
verify the credentials received in the request to authenticate the requestor being authorized to at least partially access the asset data structure;
a grant and ownership tracker system comprising:
a second memory;
a second processor; and
a second application stored at the first memory and executable by the first processor, which when executed by the first processor, causes the second application to be configured to determine whether the requestor is permitted to perform the operation with respect to the asset entry in the asset data structure based on at least one of an owner system policy, a delegate system policy, time period-to-organization mappings, or a prior transaction receipt, and
wherein the first application of the asset information service system is further configured to:
perform the operation on the asset entry of the asset data structure when the requestor is permitted to perform the operation with respect to the asset entry in the asset data structure; and
transmit a transaction receipt describing a timing and success of the operation performed on the asset entry in the asset data structure.

7. The system of claim 6, wherein the requestor is an owner system associated with an owner organization of the physical asset or a delegate system associated with a delegate organization that has temporary control over the physical asset.

8. The system of claim 6, wherein the operation is to read the asset entry in the asset data structure or to append the asset entry to an end of the asset data structure.

9. The system of claim 6, wherein the credentials comprise at least one of a digital signature of the requestor or a certificate assigned to the requestor by a certificate authority system of the system.

10. The system of claim 6, wherein the first application of the asset information service system is further configured to receive, from the requestor, a request to add a delegate system as being authorized to access the asset data structure for a period of time or remove a delegate system as no longer being allowed to access the asset data structure, wherein the request comprises a delegate system identifier identifying the delegate system and the device identifier, and wherein the second application of the grant and ownership tracker system is further configured to:
determine whether the requestor is permitted to add or remove a delegate with respect to the asset data structure based on a policy associated with the requestor;
update owner-to-delegate mappings associated with the asset data structure based on the request; and
transmit a second transaction receipt describing an update to the owner-to-delegate mappings and a timestamp of the update to the owner-to-delegate mappings associated.

11. The system of claim 6, wherein the first application of the asset information service system is further configured to receive, from the requestor, a request to modify the delegate system policy associated with a delegate system, wherein the request comprises a delegate system identifier identifying the delegate system, the device identifier, and modified access permission data for the delegate system, and wherein the second application of the grant and ownership tracker system is further configured to:
determine whether the requestor is permitted to modify the delegate system policy of the delegate system based on a policy associated with the requestor;
modify the delegate system policy of the delegate system based on the modified access permission data for the delegate system when the requestor is permitted to modify the delegate system policy; and
transmit a second transaction receipt describing a modification to the delegate system policy and a timestamp of the modification to the delegate system policy.

12. The system of claim 6, wherein the first application of the asset information service system is further configured to receive, from a delegate system, an asset status request for a status of the asset data structure from a delegate system, wherein the asset status request comprises the device identifier, and wherein the second application of the grant and ownership tracker system is further configured to:
determine whether the delegate system has permission to access a status of the asset data structure; and
transmit the status of the asset data structure to the delegate system when the delegate system has permission to access the status, wherein the status indicates whether the asset data structure is active or archived.

13. The system of claim 6, wherein the device identifier is a group device identifier identifying a plurality of physical assets that are located in a common geographic area.

14. A method, comprising:
generating, by an application executing at an asset information service system, an asset data structure for storing asset data associated with a physical asset based on a new asset data structure request received from an owner system;
generating, by an application executing at a grant and ownership tracker system, an owner system policy and a delegate system policy governing access to the asset data structure by the owner system and a delegate system based on new asset data structure request; and
performing, by the application executing at an asset information service system, a read operation or an append operation on an asset entry in the asset data structure based on an operation request received from delegate system based on the delegate system policy and a time period associated with the asset entry.

15. The method of claim 14, wherein the new asset data structure request comprises at least one of a device identifier, one or more delegate system identifiers identifying one or more delegate systems corresponding to one or more delegate organizations, asset permission data, or a digital signature associated with the owner system.

16. The method of claim 14, wherein the owner system policy and the delegate system policy are based on asset permission data received in the new asset data structure request.

17. The method of claim 14, wherein the delegate system policy indicates that the delegate system is permitted to perform the read operation or the append operation on the asset entry when the time period associated with the asset entry is a time during which a delegate organization associated with the delegate system had primary control of the physical asset.

18. The method of claim 14, wherein the operation request comprises a transaction receipt indicating that the asset entry was previously appended to the asset data structure based on a prior operation request received from the delegate system, and wherein the method further comprises determining, by the application executing at the grant and ownership tracker system, that the read operation is permitted to be performed on the asset entry based on the transaction receipt.

19. The method of claim 14, further comprising transmitting, by the application executing at the asset information service system, the asset data from the asset entry.

20. The method of claim 14, further comprising determining, by the application executing at the grant and ownership tracker system, whether the delegate system is permitted to perform the read operation or the append operation with respect to the asset entry of the asset data structure.
